(19) United States
(12) Patent Application Publication
(10) Pub. No.: US 2009/0011252 A1
(43) Pub. Date: Jan. 8, 2009

(54) PROCESS FOR APPLYING A MULTILAYERED COATING TO WORKPIECES AND/OR MATERIALS

(75) Inventors: Ralf Stein, Dortmund (DE); Gotz Matthaus, Castrop-Rauxel (DE); Oliver Noll, Schwalmstadt (DE)

Correspondence Address: RANKIN, HILL & CLARK LLP, 38210 Glenn Avenue, WILLOUGHBY, OH, 44094-7808, US

(73) Assignees: Gotz Matthaus, Castrop-Rauxel (DE); Auctio GmbH, Dortmund (DE)

(21) Appl. No.: 12/100,668

(22) Filed: Apr. 10, 2008

(30) Foreign Application Priority Data
Apr. 13, 2007 (DE) 10 2007 017 891.5
Dec. 4, 2007 (DE) 10 2007 058 484.0

(51) Int. Cl. C23C 4/10; B32B 9/04

(52) U.S. Cl. 428/446; 427/450; 428/698

(57) ABSTRACT

The invention relates to a process for applying a multilayered coating to workpieces and/or materials, comprising the following steps: applying a supporting layer to the workpiece or the material by thermal spraying or plasma spraying; applying an adhesion-promoting intermediate layer; and applying a carbon- or silicon-containing topcoat layer by plasma vapour deposition (FIG. 3B).

The present invention relates to a process for applying a multilayered coating to workpieces and/or materials according to the precharacterizing clause of claim 1.

### PRIOR ART

Surface coatings have long been used to improve the service lives and friction coefficients of workpieces and materials. Coatings containing carbon (“diamond like carbon” coatings) are used in particular.

This type of coating is distinguished by great hardness, high resistance to tribogical loads and great smoothness together with a low friction coefficient in the range of μ=0.1.

This type of coating is suitable in particular for punching, cutting, drilling and screwing tools, machining tools, prostheses, ball or roller bearings, gear wheels, pinions, drive chains, audio and drive units in magnetic recording equipment, as well as surgical and dentosurgical instruments. In particular, it is suitable for knives with exchangeable blades, for example surgical knives, and/or blades and/or knives for industrial applications.

The workpiece to be coated or the material to be coated often consists of metal, in particular of steel or high-grade steel, aluminium or titanium and their alloys. The surface of these metals is relatively soft in comparison with the coating applied, and can easily be plastically deformed. By contrast with this, although the said coating is certainly hard, it is all the same brittle. In some situations, that is for example cases of extremely high point loading, this leads to the workpiece or the material being plastically deformed and, owing to its brittleness, the coating cannot follow this deformation but breaks or peels off. This behaviour can be visualized from the image of a thin glass plate lying on a mattress and breaking when it undergoes point loading.

Tools and materials that are coated with such a coating therefore have short lifetimes and/or service lives in certain application areas and loading scenarios.

For this reason, carbon- or silicon-containing coatings are often underlaid with a supporting layer, which consists for example of metal-bound carbides, metals or oxides. These supporting layers do not have the extreme hardness of the topcoat layer but have adequately tough properties not to yield under high point loading, and so prevent breaking or peeling off of the topcoat layer.

Such a layered structure comprising a carbide-containing supporting layer and a carbon-containing topcoat layer is known for example from DE10126118.

Screwing tools with such a coating are offered for example by the company Wekador under the trade name “master.bits carbo.dlc”. The company Metaplas also offers comparable coatings under the trade name “Maxit W—C:H”.

Such a supporting layer is often applied by thermal spraying or plasma spraying of carbide- or oxide-containing powders onto the surface to be coated.

The particles of the powder flatten out on impact with the workpiece to create formations of a flat form. Since these formations of a flat form are spaced apart, voids, pores, capillaries and micro-cavities are created when this layer is applied. Only the application of further particles to an already existing layer leads to further densification of the already existing layer, since the formations of a flat form are flattened out further and thereby fill the existing intermediate spaces.

For this reason, correspondingly applied layers always have a density gradient with which the respective surface has a lower density than the layers lying thereunder. This also leads to very thin layers only having low densities and, moreover, many voids and micro-cavities, and therefore not being suitable as supporting layers in the above sense. To achieve an adequately high density, and consequently suitability as a supporting layer, the layer must therefore have a certain minimum thickness, that is to say comprise a minimum number of layers. This minimum thickness makes such supporting layers unsuitable for certain intended uses, such as for example the coating of blades and punches, since the required layer thickness cannot be combined with the necessary sharpness of these tools.

One approach to overcoming this problem is to use a grinding operation to remove the layers comprising the supporting layer, which are not suitable on account of their inadequate density, before applying the carbon- or silicon-containing layer. However, this has the effect that the effort involved in production is increased considerably and the cost-effectiveness of the manufacturing process is adversely affected.

A further problem of the combinations of a supporting layer and a carbon- or silicon-containing topcoat layer that are known from the prior art is that the two layers only adhere poorly to each other. In certain loading cases, this leads under some circumstances to delamination, and consequently to the coating being destroyed.

### DISCLOSURE OF THE INVENTION

Therefore, an object of the present invention is to provide a coating for workpieces and/or materials which imparts to their surface great hardness, great toughness, high resistance to tribological loads, great smoothness and a low friction coefficient, and which moreover is resistant to point loads.

A further object of the present invention is to provide a coating for workpieces and/or materials that is resistant to point loads and at the same time has suitable surface properties with respect to surface tension and resistance to paints and cleaning agents such as acids and alkalis, electrically insulating and heat-conducting properties, and/or biocompatibility and antiallergenic properties.

A further object of the present invention is to provide a coating for cutting, machining, drilling, forging, milling, screwing and punching tools that has a long lifetime and/or service life.

A further object of the present invention is to provide a lifetime- and/or service-life-extending coating that is suitable for blades with great sharpness.

A further object of the present invention is to provide a lifetime- and/or service-life-extending coating that has a reduced tendency for delamination of the carbon- or silicon-containing layer.

These objects are achieved by the features of the present claim 1. The subclaims specify preferred embodiments. It should be noted here that the figures given for ranges are all to be understood as including the respective limit values.

The invention accordingly provides a process for applying a multilayered coating to workpieces and/or materials, comprising the following steps:
a) applying a supporting layer to the workpiece or the material by thermal spraying or plasma spraying;
b) applying an adhesion-promoting intermediate layer; and
c) applying a carbon- or silicon-containing topcoat layer by plasma vapour deposition.

The thermal spraying process is preferably high-velocity oxy-fuel spraying (HVOF), which is explained in more detail further below.

With particular preference, the topcoat layer is a carbon-containing layer; in particular a layer of a DLC (“diamond like carbon”) material.

The workpiece or the material may consist in particular of ceramic, iron, steel, high-alloy steel, nickel, cobalt and their alloys with chromium, molybdenum and aluminium, copper and copper alloys, titanium or alloys that comprise the aforementioned materials. Furthermore, the workpiece or the material may consist of metals and/or metallic alloys based on Zn, Sn, Cu, Fe, Ni, Co, Al, Ti, and the refractory metals such as Mo, W, Ta, etc. Furthermore, sintered metal materials and metal-ceramic composites (MMC) and metal-polymer composites as well as ceramic materials of oxides, carbides, borides and nitrides come into consideration.

With particular preference, the process is characterized in that the supporting layer is applied by a metallic powder being applied to the workpiece or the material by thermal spraying (in particular high-velocity oxy-fuel spraying) or plasma spraying.

Coming into consideration here in particular as the metallic powder is a powder that has a constituent selected from the group comprising aluminium carbide (Al₄C₃), aluminium nitride (AlN), aluminium oxide (Al₂O₃), aluminium titanium oxide (Al₂O₃—TiO₂), aluminium zirconium oxide (Al₂O₃—ZrO₂), boron carbide (B₄C), boron nitride (hexagonal) (BN), calcium tungstate (CaWO₄), calcium niobate, chromium boride (CrB, CrB₂), chromium disilicide (CrSi₂), chromium carbide nickel (Cr₃C₂—Ni), chromium carbide nickel/cobalt nickel chromium/nickel aluminium (Cr₃C₂—Ni/CoNiCr/NiAl), chromium carbide nickel chromium (Cr₃C₂—NiCr), chromium carbide (Cr₂C₃), chromium alloys, chromium nitride (CrN, Cr₂N), chromium oxide (Cr₂O₃), chromium titanium oxide (Cr₂O₃—TiO₂), chromium titanium silicon oxide (Cr₂O₃—TiO₂—SiO₂), CoNi—CrAlYs (CoNiCrAlTaReY), CoNi—CrAlYs (CoNiCrAlY), iron powder, copper-enclosed (FeCu), ferrochromium nickel molybdenum silicon (FeCrNiMoSiC), cobalt nickel chromium alloy (CoNiCrAlY), cobalt aluminium catalyst alloys, cobalt catalyst, cobalt alloys, atomized, lanthanum hexaboride (LaB₆), lithium/nickel/cobalt oxide, lithium nitride (Li₃N), magnesium diboride (MgB₂), magnesium niobate, metal carboxylates, molybdenum metal powder (Mo—Mo₂C), molybdenum metal powder, doped (TZM), molybdenum metal powder (Mo), molybdenum nickel SF metal powder (Mo—NiSF), molybdenum boride (MoB, MoB₂), molybdenum dioxide (MoO₂), molybdenum disilicide (MoSi₂), molybdenum carbide (Mo₂C), Ni—CrAlYs (NiCoCrAlY), Ni—CrAlYs (NiCrAlY), nickel aluminium catalyst alloys, nickel catalyst, nickel niobium (NiNb), nickel-based brazing alloys, atomized, nickel chromium (NiCr), nickel chromium boron silicon (NiCrBSi), nickel chromium cobalt (NiCrCo), nickel graphite (NiC), nickel hydroxide (regular, spherical), niobium metal powder (Nb), niobium boride (NbB, NbB₂), niobium disilicide (NbSi₂), niobium carbide (NbC), niobium nitride (NbN), niobium oxide, niobium pentoxide (Nb₂O₅), silicon hexaboride (SiB₆), silicon carbide (SiC), silicon metal powder (Si), silicon nitride (Si₃N₄), tantalum metal powder (Ta), tantalum niobium carbide, tantalum boride (TaB, TaB₂), tantalum disilicide (TaSi₂), tantalum carbide (TaC), tantalum nitride (TaN), tantalum oxide, tantalum carbon nitride (Ti (C, N)), titanium diboride (TiB₂), titanium disilicide (TiSi₂), titanium carbide (TiC), titanium nitride (TiN), titanium oxide (TiO₂), vanadium carbide (VC), tungsten metal powder WMP (W), tungsten titanium carbide, tungsten boride (WB, W₂B₅), tungsten disulphide (WS₂), tungsten carbide chromium carbide nickel (WC—CrC—Ni), tungsten carbide cobalt chromium (WC—Co—Cr), tungsten carbide cobalt nickel SF (WC—Co—NiSF), tungsten carbide nickel (WC—Ni), tungsten carbide nickel molybdenum chromium oxide cobalt (WC—NiMoCrFeCo), tungsten carbide (WC), tungsten oxide (WO₃), tungsten melt carbide (W₂C/WC), tungsten silicide (WSix), yttrium oxide (Y₂O₃), zirconium diboride (ZrB₂), zirconium disilicide (ZrSi₂), zirconium carbide (ZrC), zirconium nitride (ZrN), zirconium yttrium oxide (ZrO₂—Y₂O₃).

The powder is, with particular preference, a powder comprising metal-bound carbides. Coming into consideration here in particular as metal-bound carbides are tungsten carbide cobalt (WC—Co), chromium carbide nickel (Cr₃C₂—Ni), TiC—Fe and their mixtures, the latter also metallically bonded with the metals Cu, Fe, Ni and Co, or their alloys and superalloys with chromium, molybdenum, silicon and aluminium. Particularly preferred are tungsten carbide cobalt (WC—Co), tungsten carbide cobalt chromium (WC—CoCr), chromium carbide nickel chromium (Cr₃C₂—NiCr₂₀), chromium carbide nickel chromium molybdenum niobium (Cr₃C₂—NiCrMoNb) and titanium carbide iron chromium molybdenum aluminium (TiC—FeCrMoAl).

In another preferred embodiment, it is provided that the powder is a powder comprising oxides.

Aluminium oxide, titanium dioxide, chromium oxide, magnesium oxide, zirconium oxide and their alloys and mixtures come into consideration here in particular as oxides.

The proportion of metal-bound carbides or oxides in a supporting layer is with preference in a range of 30% by volume-90% by volume.

In a further preferred embodiment, metals and alloys come into consideration in particular for the powder, of these in particular metals and metallic alloys based on Cu, Fe, Ni, Co, Al, Ti and the refractory metals such as Mo, W, Ta, etc. In particular, Fe, Ni and Co alloys (M=Fe, Ni, Co) of the types MCr, MCrB and MCrBSi alloys with fractions of Mo, Ti, W, Nb and carbon may be used here.

It is provided with particular preference that the supporting layer is applied by high-velocity oxy-fuel spraying. In high-velocity oxy-fuel spraying (HVOF), the sprayed powder is sprayed at very high velocity onto the substrate to be coated. The heat for melting the powder is produced by the reaction of oxygen and fuel gas in the combustion chamber. The temperatures that are reached in the flame are up to approximately 3000° C. The reaction causes the gas to expand and accelerates the sprayed powder to a high velocity.

Here it is provided with preference that particle velocities of 400-2000 m/s are achieved. In this way, the workpiece or the material is as it were hammer-coated, which is to say that processes similar to forging occur, creating an intimate bond between the workpiece or the material and the coating.

This process is suitable in particular for the aforementioned metal-bound carbides, since they can only withstand temperatures of up to 3000° C. At temperatures above that, they oxidize, since high-velocity oxy-fuel spraying takes place under atmospheric conditions.

In another preferred embodiment, it is provided with preference that the supporting layer is applied by plasma spraying. A plasma torch in which an anode and a cathode are separated by a narrow gap is generally used for this process. An arc is produced between the anode and the cathode by a d.c. voltage. The gas flowing through the plasma torch is passed through the arc and thereby ionized. The ionization, or subsequent dissociation, produces a highly heated (up to 20,000 K), electrically conducting gas of positive ions and electrons. Powder is injected into the plasma jet produced in this way and is melted by the high plasma temperature. The plasma gas stream entrains the powder particles and accelerates them at a velocity of up to 1000 m/s onto the workpiece to be coated. After only an extremely short time, the gas molecules revert to a stable state and no longer release any energy, and so the plasma temperature drops again after only a short distance has been covered. The plasma coating generally takes place under atmospheric pressure. The kinetic and thermal energy of the plasma are particularly important factors for the quality of the layer. Gases used are argon, helium, hydrogen, oxygen or nitrogen.

The use of a plasma torch which is characterized by axial powder injection and a multi-cathode construction is preferred in particular.

Furthermore, it is provided with preference that the powder used has a d₅₀ value of ≧0.1 and ≦15 μm. The aforementioned d₅₀ value denotes the median of the particle size of the powder used, i.e. the value with respect to which 50% of the particles used are larger and 50% of the particles used are smaller.

In the prior art, powder with particle sizes of 5-120 μm is used for plasma spraying or high-velocity oxy-fuel spraying. The d₅₀ value of these powders is around 16-60 μm. According to the invention, on the other hand, the use of powders with a d₅₀ value as defined above is envisaged, in preferred embodiments with this value at 12 μm (particle sizes between 5 and 15 μm), 6 μm (particle sizes between 3 and 10 μm) and with particular preference at 3 μm (particle sizes between 1 and 5 μm) and with particular preference at 1 μm (particle sizes between 0.1 and 3 μm).

It is decisive here that the use of finer particles makes it possible for the first time to form layers that are very thin and at the same time highly dense, which enables them in spite of the small thickness to act as a stable supporting layer for the topcoat layer that is subsequently to be applied.

In principle, the application of particles to a workpiece or a material leads at first to the formation of a layer that has voids, pores, micro-capillaries and micro-cavities.

So it is that, for example, at the velocities mentioned, particles with a diameter of 50 μm flatten out on impact with a workpiece to create formations of a flat form with a thickness of approximately 8 μm. Since these formations of a flat form are spaced apart, micro-cavities with a height of approximately 8 μm are created when this layer is applied. Only the application of particles to an already existing layer leads to further densification of the already existing layer, since the formations of a flat form are flattened out further and thereby fill the existing intermediate spaces. Therefore, with relatively large particles, a layer with an adequately high density cannot be produced on the surface.

The use of ultrafine particles, on the other hand, makes it possible for the first layer that is applied already to have a high density, since the formations of a flat form created on impact with the surface—and the voids and micro-cavities that are consequently created—have a smaller thickness. So it is that a particle with a diameter of 5 μm flattens out on impact with the surface to form a formation of a flat form with a thickness of approximately 0.5 μm. Therefore, micro-cavities with a height of only approximately 0.5 μm are thereby created. So it becomes possible to produce layers which, in spite of a small thickness, have a high density and/or also have an adequately high density at their surface.

In addition to this effect, particles of the size range that is preferred according to the invention can be accelerated to very much higher velocities in thermal spraying and in plasma spraying, and therefore impinge on the surface of the material or workpiece to be coated with very much higher kinetic energies. For example, particles with a diameter of 40 μm can be accelerated to 200 m/s, particles with a diameter of 5 μm on the other hand can be accelerated to 1000 m/s and particles with a diameter of 1 μm can be accelerated to 1400 m/s. Smaller particles can be accelerated to even higher values.

Particles of the size range that is preferred according to the invention therefore flatten out proportionally very much more on impact than larger particles, which are accelerated to a lesser degree and therefore have relatively lower kinetic energies. This phenomenon likewise contributes to a considerably greater density and fewer and smaller voids and micro-cavities of the layer produced according to the invention.

For this reason there is no longer any need with the supporting layer produced according to the invention for re-grinding of the porous constituents of the layer that cannot be used, as is required when larger particles are used.

One advantage of the supporting layer produced according to the invention is in particular that a layer that is very thin but at the same time has an adequate density to ensure reliable support of the topcoat layer to be applied is produced here, so that the latter is protected from breaking and the like. Until now, this was only possible with considerably thicker supporting layers, which however made application impossible on certain workpieces, such as for example knife blades, blades of punching tools and the like. The process according to the invention consequently allows for the first time a supporting layer that is applied by plasma or high-velocity oxy-fuel spraying to be applied to critical workpieces, such as for example blades or punching tools, or allows the latter to be produced from workpieces coated according to the invention.

Until now, powders of the claimed size ranges could not be produced, or could not be produced cost-effectively. The originators of the present invention have produced powders of these size ranges for this first time in large quantities, consequently make them available for use in plasma or high-velocity oxy-fuel spraying.

In addition to this, fine and ultrafine powders cannot be used in the plasma and high-velocity oxy-fuel spraying devices that are known in the prior art. In the case of plasma spraying devices there is, in particular, the difficulty that in these devices the powders are fed in laterally. Since a plasma jet has a relatively high viscosity, which corresponds approximately to that of vegetable oil, powders that are brought in from the side can no longer be mixed into the jet if they are below a certain size, but instead bounce off.

The originators of the present invention have solved this problem by the development of a feeding device that is specifically suited for this purpose, which is the subject matter of a separate patent application.

A further problem is that the conveying devices used in the plasma and high-velocity oxy-fuel spraying devices that are known in the prior art cannot convey powders of the claimed sizes with adequately high reproducibility. The originators of the present invention have also solved this problem by the development of a conveying device that is specifically suited for this purpose.

With preference, the powder used according to the invention has a maximum particle size of ≦20 μm, ≦15 μm, ≦10 μm, ≦5 μm, ≦3 μm or ≦1 μm. The carbidic starting material has with preference a maximum particle size of ≦10 μm. With particular preference, it has a particle size of ≦3 μm, ≦1 μm, ≦0.5 μm, ≦0.3 μm or ≦0.15 μm.

The types of powder may be, in particular, mixed powders, agglomerated and sintered powders, coated powders and coated carbides with alloys.

The applied supporting layer has with preference a thickness of between 10 μm and 3000 μm, with particular preference between 30 μm and 200 μm.

The thickness of the supporting layer is dependent on the size of the particles used, the duration of the coating operation and the further process parameters. Although the particles impinge in a randomly distributed manner on the surface to be coated (known as shot noise), it can be assumed for example that, in the case of particles used according to the invention with a d₅₀ value of 5 μm, a single layer as a thickness of approximately 0.5 μm.

With preference, the supporting layer has a thickness in the range of 10-1000 μm, with particular preference 20-100 μm.

With preference, the following process parameters are thereby maintained:

High velocity oxy-fuel spraying:
WC—Co 83 17 powder agglomerated sintered grain size 3-10 μm
HVOF torch of the CJS type from the company Thermico
oxygen 15-52 m²/h
hydrogen 40-200 l/min
kerosene 2-14 l/h
powder feed 10-60 g/min
powder feeding gas nitrogen 3-15 l/min
accelerator nozzle D10/100 mm
combustion chamber type K5.2
spraying distance 70-250 mm

Plasma spraying:
aluminium oxide 99.5 melted crushed grain size 1-5 μm
axial plasma Thermico
argon 60-120 l/min
nitrogen 10-60 l/min
hydrogen 10-60 l/min
powder feed 10-90 g/min
powder feeding gas argon 2-10 l/min
plasma nozzle ⅜″
spraying distance 50-200 mm

The supporting layer produced according to the invention has with preference a hardness of 500-2000 HV 0.3, with particular preference of 800-1250 HV 0.3 (measured according to Vickers HVO 0.3).

Owing to its unfavourable state of internal stress and the great hardness of the supporting layer, the carbon- or silicon-containing layer adheres only very poorly to it. The latter adheres much better for example to a high-grade steel surface, since it is very much softer. For this reason, an intermediate layer intended to serve as an adhesion promoter between the supporting layer and the topcoat layer is provided according to the invention. Such an adhesion promoting layer has not so far been described in the prior art.

It is provided with particular preference that the intermediate layer comprises elements from the 6th and 7th subgroups. With preference, compounds which contain the elements Cr, Mo, W, Mn, Mg, Ti and/or Si, and in particular mixtures of the same, are used here. Similarly, the individual constituents may be distributed in a graduated manner over the depth of the adhesion promoting layer.

It is provided with particular preference in this respect that the intermediate layer is applied to the supporting layer by means of plasma vapour deposition.

This adhesion promoting layer has a neutral state of internal stress and, on account of its property of being elastically and plastically deformable, has the effect of evening out the internal stresses. It has a wider uncritical production parameter range in comparison with a carbon- or silicon-containing topcoat layer, which requires greatly restricted conditions on the surface.

The PECVD (plasma enhanced CVD) process is used with preference for the application of the intermediate or adhesion promoting layer. This is the “plasma enhanced chemical vapour deposition” process, also termed “plasma vapour deposition”; it is a special form of “chemical vapour deposition” (CVD) in which the deposition of the layers takes place by chemical reaction in a vacuum chamber; the material with which the coating is to be performed is in this case in the gaseous or vaporous phase.

In addition, the process is assisted by a plasma. For this purpose, a strong electric field is applied between the substrate to be coated and a counter electrode and is used for igniting a plasma. The plasma has the effect of breaking up the bonds of the reaction gas and breaking the latter down into radicals, which are deposited on the substrate and bring about the chemical depositing reaction there. As a result, a higher depositing rate can be achieved at a lower depositing temperature than with CVD.

The thickness of the intermediate layer is with preference between 20 nm and 2000 nm, with preference between 20 nm and 100 nm. It therefore corresponds in an extreme case to an atomic layer. In principle, the thickness of the intermediate layer is very difficult to determine; the reasons for this will be further discussed later.

With preference, the supporting layer is activated by sputtering before the application of the adhesion-promoting intermediate layer. This step has the effect of significantly improving the adhesive bond between the intermediate layer and the supporting layer.

Sputtering is meant in this context as meaning sputter-etching. This involves accelerating gas ions in the plasma, their kinetic energy then making them attack the workpiece to be coated with an etching effect. No chemical reaction occurs here; it is a purely physical process.

The reaction gases oxygen, hydrogen and/or argon are used with preference here for the sputtering.

With particular preference, moreover, it is provided that the step of applying the adhesion-promoting intermediate layer and the step of applying a carbon- or silicon-containing topcoat layer are merged together gradually upon transition of said first step to said second step.

As already mentioned at the beginning, in this preferred embodiment the topcoat layer is likewise applied by plasma vapour deposition. Apart from an inert shielding gas, a carbon- or silicon-containing reaction gas, such as for example methane (CH₄), ethane (C₂H₄), acetylene (C₂H₂) or methyl trichlorosilane (CH₃SiCl₃), is used with preference here. In this way it is possible, for example, to deposit a carbon-containing topcoat layer, which often has diamond-like properties and structures and is therefore also referred to as a DLC (“diamond like carbon”) layer.

On the other hand, a silicon nitride layer is produced by using the reaction gases ammonia and dichlorosilane. For silicon dioxide layers, the reaction gases silane and oxygen are used. For the production of metal/silicon hybrids (silicides), tungsten hexafluoride (WF₆) is used for example as the reaction gas.

Titanium nitride layers for the hardening of tools are produced from TDMAT (tetrakis dimethylamino titanium) and nitrogen. Silicon carbide layers are deposited from a mixture of hydrogen and methyl dichlorosilane (CH₃SiCl₃).

According to the invention, it is provided that the two layers merge together in the boundary region. This is achieved according to the invention by the steps of applying the intermediate layer and the topcoat layer being merged together gradually upon transition of said first step to said second step.

For this purpose, ramps have to be set, i.e. a smooth transition with a specific temporal gradient must be set up for the transition from the coating gas for the intermediate layer to the coating gas for the topcoat layer. The same applies to the changing of the bias number at the transition from the intermediate layer to the topcoat layer, and if appropriate to further coating parameters.

Said ramps may take the following form: after the sputtering step, the bias voltage V_{bias} is raised to the desired level 5 s before the beginning of the application of the intermediate layer. After that, the reaction gas for the adhesion promoter is let in with an extremely short ramp (10 s). Once the application time for the adhesion promoter has elapsed, the acetylene valve is gradually opened to the desired inlet value over a time period of 500 s. Simultaneously, the adhesion promoter valve gradually closes in the same time. Subsequently, the topcoat layer is also applied over the desired time. In the case of critical components, the reaction gas for the adhesion promoter may continue to be supplied with a low volume per minute up to the completion of the coating process. Table 1 shows this process with values that are given by way of example:

TABLE 1

| Time | | | H₂/O₂ | TMS/Ti | C₂H₂ |
|---|---|---|---|---|---|
| (s) | Step | V_{bias} | (sccm) | (sccm) | (sccm) |
| −200 | sputtering | 300 | 50/150 | 0 | 0 |
| −5 | ramp | 300 | 50/150 | 0 | 0 |
| 0 | intermediate | 350 | 0 | 0 | 0 |
| | layer | | | | |
| 10 | | 350 | 0 | 300 | 0 |
| 600 | ramp | 350 | 0 | 300 | 0 |
| 1100 | topcoat | 350 | 0 | 0 | 250 |
| | layer | | | | |
| X | topcoat | 350 | 0 | 0 | 250 |
| | layer | | | | |

The “sccm” dimension used stands for standard cubic centimetres per minute and represents a standardized volumetric flow. In vacuum pumping technology, reference is also made to the gas load. A defined amount of flowing gas (number of particles) per unit of time is expressed by this standard independently of pressure and temperature. One sccm corresponds to a gas volume of V=1 cm³=1 ml under standard conditions (T=20° C. and p=1013.25 hPa).

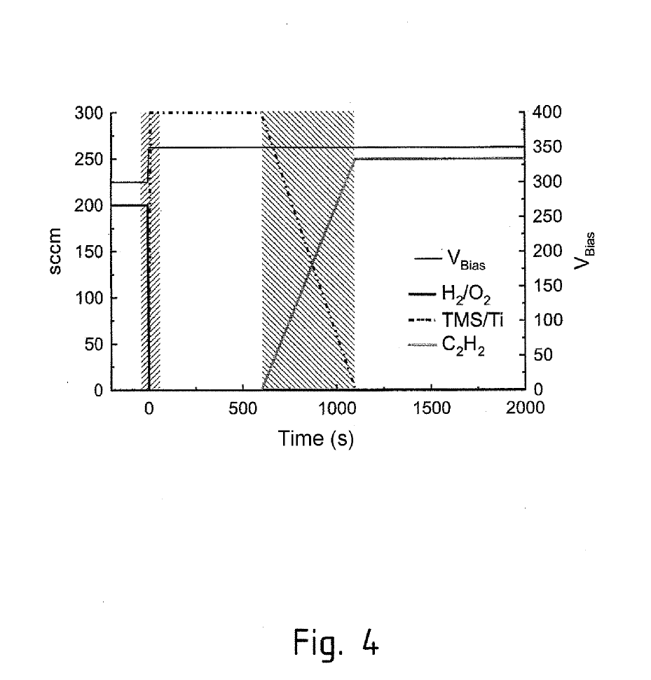

The ramps presented by way of example are shown in FIG. 4 as a diagram. As a departure from the values shown in Table 1, essentially the following parameter ranges are preferred for the various steps:

TABLE 2

| | | H₂/O₂ | Ar | TMS/Ti | C₂H₂ | |
|---|---|---|---|---|---|---|
| Step | V_{bias} | (sccm) | (sccm) | (sccm) | (sccm) | Press/temp |
| sputtering | 300-600 | 0-200/ | 0-70 | 0 | 0 | 0.5-2 P |
| | | 0-200 | | | | 50-150° C. |
| inter- | 200-500 | 0 | | 100-500 | 0 | 0.1-2 P |
| mediate | | | | | | 50-150° C. |
| layer | | | | | | |
| topcoat | 250-600 | 0 | | 0-90 | 100-500 | 0.01-0.9 P |
| layer | | | | | | 50-150° C. |

Similarly, it may be provided, moreover, that ramps are operated with respect to the materials used for the adhesion promoting layer. So it may be provided during the application that one material is successively replaced by another.

When applying the topcoat layer in the plasma vapour deposition chamber, moreover, the following process parameters are maintained with preference:

TABLE 3

| | |
|---|---|
| Temperature: | 50-150° C., with preference |
| | 80° C. |
| Chamber volume: | 200-10,000 l, with |
| | preference 900 l |
| Chamber pressure: | 0.0-3.0 Pa, with |
| | preference 0.0-2.0 Pa |
| Bias voltage: | 200 volts-600 volts |
| Duration: | 1-100 min. |
| Gas flow: | 50 sccm-700 sccm |

The gas concentration in the chamber is obtained in each case from the gas flow, the volume of the chamber and the pressure prevailing in it. For a chamber with a volume of 900 l and a pressure prevailing in it of 0.0-2.0 Pa, a concentration of 0.011% of the chamber volume is obtained for example for acetylene (C₂H₂) in the case of a gas flow of 100 sccm (0.1175 g per minute). Further gas flows to be set with preference are, for example, 200 sccm (0.2350 g per minute of C₂H₂=0.022%), 300 sccm (0.3525 g per minute of C₂H₂=0.033%), 400 sccm (0.4700 g per minute of C₂H₂=0.044%) and 500 sccm (0.5875 g per minute of C₂H₂=0.055%).

A DLC layer produced in this way by using acetylene as the reaction gas has a hardness of 6000-8000 HV and a thickness of 0.90 μm to 5.0 μm.

The invention also relates to a multilayered coating on workpieces and/or materials, comprising the following layers:
a) a supporting layer comprising ultrafine particles applied by thermal spraying or plasma spraying;
b) an adhesion-promoting intermediate layer; and
c) a carbon- or silicon-containing topcoat layer.

The material properties of this coating, its starting materials and the process properties and parameters for its production are disclosed in conjunction with the process claims already discussed and are intended to be regarded as also disclosed with respect to the coating as such. This applies in particular to the very thin supporting layer, of a nevertheless great hardness and density, that can be achieved, consisting with preference of metal-bound carbides or oxides, and also to the transition between the adhesion-promoting intermediate layer and the carbon- or silicon-containing topcoat layer that can be achieved by the ramps mentioned.

A multilayered coating on workpieces and/or materials that can be produced by one of the processes described above is similarly provided.

Furthermore, an instrument, workpiece or material or component that is coated by one of the processes described above or with a multilayered coating according to the above description is provided according to the invention.

This instrument may be, for example, a surgical instrument, such as for example a scalpel. Similarly, this instrument may be a punching tool. Furthermore, the instrument may be, for example, a butcher's cutting tool.

The service lives of the instruments mentioned are extended, sometimes considerably, by the coating according to the invention. So it is that cutting tools coated according to the invention retain their sharpness for considerably longer, to be precise even if they are used under adverse conditions. This applies in particular to butcher's cutting tools, which on the one hand have to cut soft material (fat, muscle, skin, connective tissue), but on the other hand also have to cut hard material, such as for example bones and frozen meat.

Another example is that of surgical instruments, which often have to be sterilized, which in the case of instruments not coated according to the invention leads after a short time to strong corrosion as a result of the sterilizing conditions (heat, moisture and pressure). As a result, on the one hand the suitability of the instrument as such is impaired, and on the other hand in particular the sharpness of the blades used suffers.

Further components to be coated according to the invention are, for example:
seals and components of rotating machines such as pumps, gas compressors and turbines, in particular seals between a rotating component and a stationary housing,
components that are subject to adhesive wear and typical fretting and pitting,
pneumatic and hydraulic systems, in particular the sealing system of a rod and cylinder, the sealing elements and the surfaces of rods and cylinders,
engine units and components, in particular pistons with or without piston rings, cylinder liners and barrels, valves and camshafts, pistons and con rods,
components of machines that are exposed to aggressive chemical processes and the metallic surfaces and/or metallic substrates of which are chemically attacked and corroded,
components that have high biocompatibility requirements; in particular implants, screws, plates, artificial joints, stents, biomechanical and micromechanical components,
surgical instruments, which always have to be antiallergenic, such as for example scalpels, forceps, endoscopes, cutting instruments, clamps, etc.,
components that have to have surfaces that are chemically resistant to printable inks and cleaning agents and the surfaces of which require defined anti-adhesive and liquid-repellent and/or liquid-adherent properties for defined ink metering, such as for example rollers, cylinders and strippers of printing machines,
components in current-carrying machines, computers and installations that require a heat-dissipating but electrically insulating surface coating, such as for example magnetic storage media and installations of moving power leads,
moving media conduits for gas, liquid and gas- or liquid-fluidized solid media.

In principle, pairings in machines and installations with frictional/sliding wear can be advantageously coated according to the invention, since they are exposed to high pressures and/or temperatures.

### DRAWINGS AND EXAMPLES

The present invention is explained in more detail by the figures and examples shown and discussed below. It must be noted here that the figures and examples are only of a descriptive character and are not intended to restrict the invention in any form.

### Example 1

A butcher's knife coated by the process described (layer structure: DLC topcoat layer with intermediate layer on an HVOF coating of metal-bound tungsten carbide of the type WC—Co 83 17) had a service life three times that of a conventional butcher's knife with a combination coating.

### Example 2

An industrial potato cutting knife coated by the process described had a service life extended by eight times in comparison with a conventional cutting knife with a combination coating.

### Example 3

A punching tool for the production of electrical plug-in connectors for the automobile industry coated by the process described had a service life extended by two times in comparison with a conventional punching tool.

### DRAWINGS

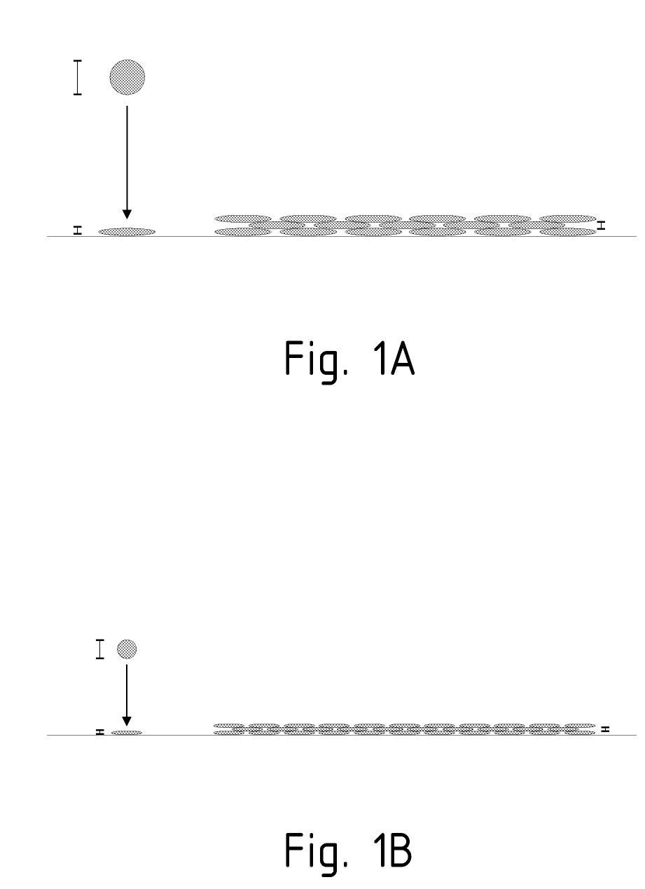

FIG. 1A shows a model of the behaviour of particles of relatively large diameter which are applied to a surface by means of one of the processes described (i.e. thermal spraying or plasma spraying). The particles flatten out on impact with the workpiece to create formations of a flat form with a specific thickness (see scale). Since these formations of a flat form are spaced apart, micro-cavities with a corresponding height are created when this layer is applied.

In FIG. 1B, these phenomena are shown for the use of particles of only half the size in order to illustrate the advantage of the present invention. The formations of a flat form that occur on impact have a smaller thickness, and the micro-cavities created correspondingly have a smaller height. The layer is therefore provided overall with a higher density.

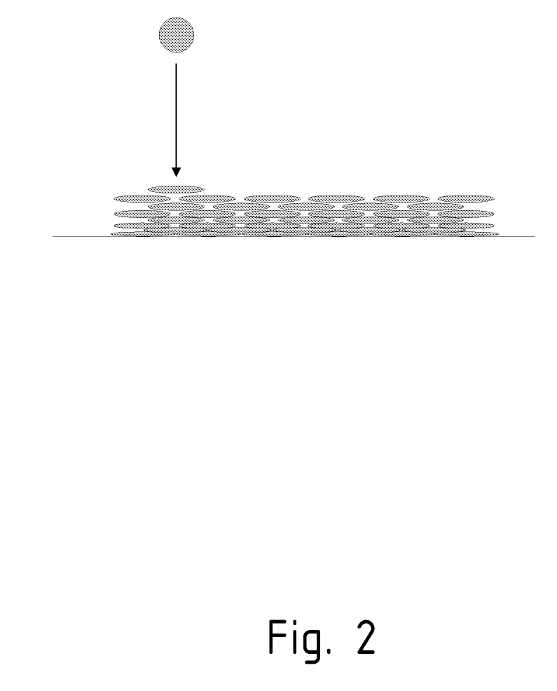

FIG. 2 shows in the model the behaviour described when a number of layers of particles of relatively large diameter are applied. In this case, the application of particles to an already existing layer leads to further densification of the already existing layer, since the formations of a flat form are flattened out further and thereby fill the existing intermediate spaces. Therefore, with relatively large particles, a layer with an adequately high density cannot be produced on the surface.

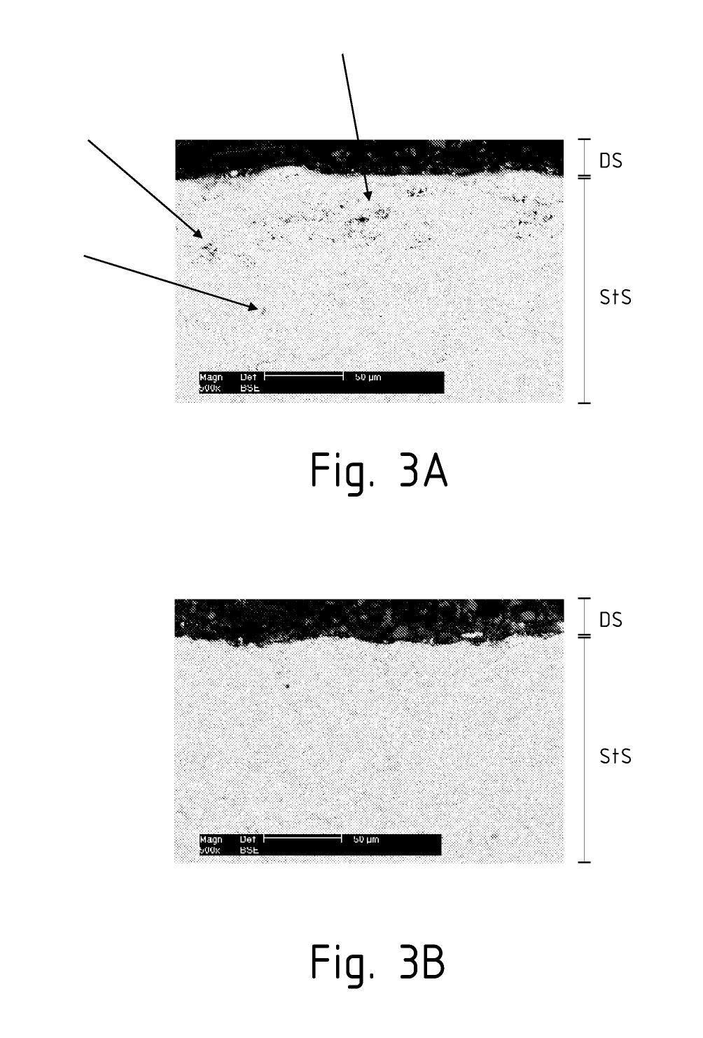

FIG. 3A shows the photomicrograph of a section through a supporting layer (StS) and a topcoat layer (DS) applied on it, which has been applied to a workpiece with a powder according to the prior art (WC—Co 83 17) by means of high-velocity oxy-fuel spraying. The spraying parameters were as follows:
HVOF torch of the type CJS from the company Thermico
oxygen 45 m²/h
hydrogen 60 l/min
kerosene 18 l/h
powder feed 60 g/min
powder feeding gas nitrogen 8 l/min
accelerator nozzle D10/140 mm
combustion chamber type K4.2
spraying distance 350 mm

The d₅₀ value of the particles applied was 30 μm. It is clearly evident that the layers near the surface have very many micro-cavities, voids and the like (see arrows), while the lower layers have an overall higher density. FIG. 3A therefore shows the phenomena represented by way of a model in FIG. 2 when relatively large particles are used.

FIG. 3B shows the photomicrograph of a section through a supporting layer (StS) according to the invention and a topcoat layer (DS) applied on it. The intermediate layer cannot be seen because of its small thickness. The supporting layer consists of ultra-finely powdered WC—Co 83 17 and was applied in a way similar to the supporting layer shown in FIG. 3A.

The spraying parameters were as follows:
HVOF torch of the type CJS from the company Thermico
oxygen 45 m²/h
hydrogen 60 l/min
kerosene 8 l/h
powder feed 40 g/min
powder feeding gas nitrogen 8 l/min
accelerator nozzle D10/100 mm
combustion chamber type K5.2
spraying distance 120 mm

The d₅₀ value of the particles applied was 6 μm. It is clearly evident that the layer has a uniformly high density over its entire depth, and that in particular the layers near the surface scarcely have any micro-cavities, voids and the like. It is also evident that the surface of the coating is very much smoother and more precisely defined than the supporting layer shown in FIG. 3A. Therefore, unlike the supporting layer in FIG. 3A, it is generally no longer necessary for the supporting layer applied according to the invention to be re-ground before application of the intermediate layer and the topcoat layer.

FIG. 4 shows a diagram of the variation over time of the ramps described in Table 1. The regions with a shaded background indicate the ramps.

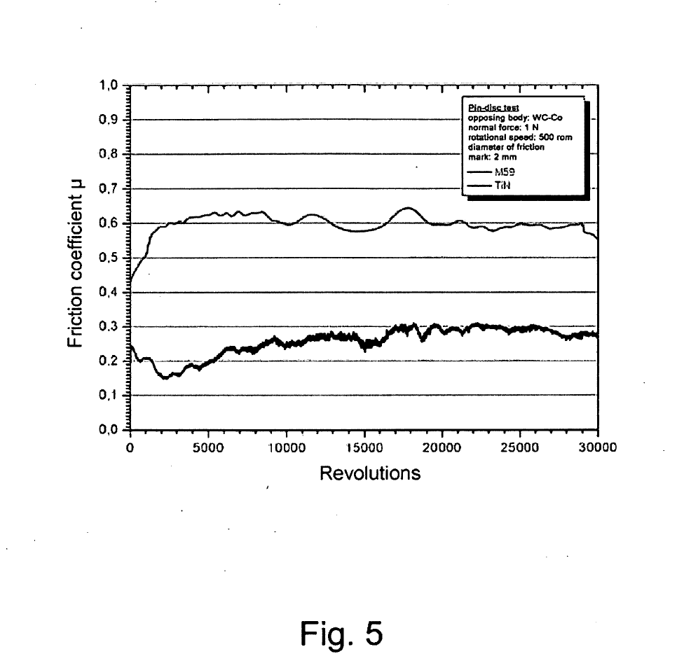

FIGS. 5-7 show the results of the physical analysis of three high-grade steel workpieces, one of which is provided with a titanium nitride coating (“TiN”) and the two others are provided with coatings according to the invention (“M44”, layer thickness 0.81 μm, “M59”, layer thickness 0.84 μm, layer structure: DLC topcoat layer with intermediate layer on an HVOF coating of metal-bound tungsten carbide of the type WC—Co 83 17).

Titanium nitride is considered in the prior art to be one of the hardest and most resistant coatings for cutting, milling and punching tools.

The friction and wear testing was carried out in accordance with SOP 4CP1 (pin-disc tribology) with the measuring instrument: CSEM pin disc tribometer.

The following process parameters were maintained during this:

### Stress Collective:

opposing body: WC—Co ball, diameter 6 km
lubricant: none
normal force FN: 1 N
rotational speed: 500 rpm
sliding rate v: 52.4 mm/s
diameter of friction mark D: 2 mm

### Boundary Conditions:

ambient temperature: 23° C.+/−1K

relative atmospheric humidity: 50%+/−6%

FIG. 5 shows the results of the determination of the friction coefficient μ. It is clearly evident that the coating according to the invention, with an average friction coefficient μ of approximately 0.3, has significant advantages over the TiN coating, the average friction coefficient of which is almost always twice as high.

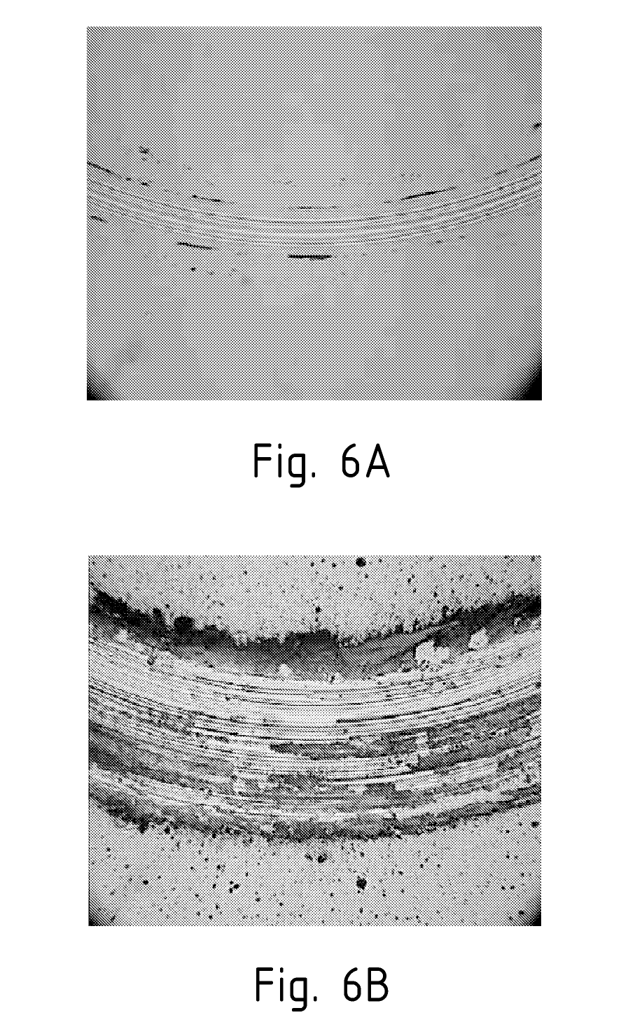

FIG. 6 shows the light-microscopic documentation (magnification: 100×) of the wear in the fiction mark after 30,000 revolutions in the case of the coating according to the invention M59 (FIG. 6A) and the TiN coating (FIG. 6B). It is clearly evident here that the coating according to the invention exhibits much lower wear than the TiN coating.

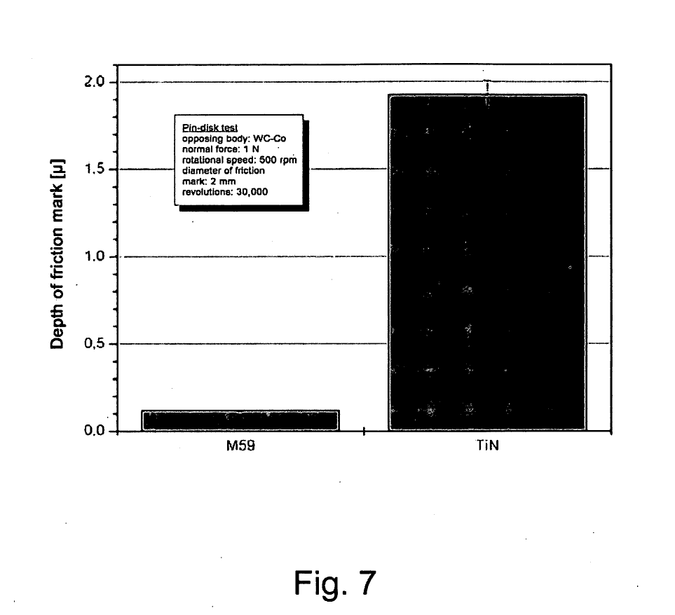

FIG. 7 shows the results of the photometric evaluation of the depth of the friction mark after 30,000 revolutions. Here, too, it is clearly evident that the coating according to the invention exhibits much lower wear than the TiN coating.

1. A process for applying a multilayered coating to a workpiece or a material, comprising the following steps:
a) applying a supporting layer to the workpiece or the material by thermal spraying or plasma spraying;
b) applying an adhesion-promoting intermediate layer; and
c) applying a carbon-containing or a silicon-containing topcoat layer by plasma vapor deposition.

2. The process according to claim 1, wherein the supporting layer is applied by a metallic powder being applied to the workpiece or the material by thermal spraying or plasma spraying.

3. The process according to claim 2, wherein the powder is a powder comprising metal-bound carbides.

4. The process according to claim 2, wherein the powder is a powder comprising oxides.

5. The process according to claim 2, wherein the powder is a powder comprising metal alloys.

6. The process according to claim 1, wherein the supporting layer is applied by high-velocity oxy-fuel spraying.

7. The process according to claim 1, wherein the supporting layer is applied by plasma spraying.

8. The process according to claim 1, wherein the powder used has a d₅₀ value of ≧1 and ≦15 μm.

9. The process according to claim 1, wherein the supporting layer applied has a thickness of between 10 μm and 3000 μm.

10. The process according to claim 1, wherein the intermediate layer comprises elements from the 6th and 7th subgroups.

11. The process according to claim 1, wherein the intermediate layer is applied to the supporting layer by means of plasma vapor deposition.

12. The process according to claim 1, wherein the supporting layer is activated by sputtering before the application of the adhesion-promoting intermediate layer.

13. The process according to claim 1, wherein the step of applying the adhesion-promoting intermediate layer and the step of applying the carbon-containing or the silicon-containing topcoat layer are merged together gradually upon transition of said first step to said second step.

14. A multilayered coating on a workpiece or a material, comprising the following layers:
a) a supporting layer comprising ultrafine particles applied by thermal spraying or plasma spraying;
b) an adhesion-promoting intermediate layer; and
c) a carbon-containing or a silicon-containing topcoat layer.

15. A multilayered coating on a workpiece and/or a material produced by a process according to claim 1.

16. An instrument, workpiece or material or component that is coated by a process according to claim 1.

17. The process according to claim 1, wherein the supporting layer applied has a thickness of between 30 μm and 200 μm.

18. An instrument, workpiece or material or component that is coated with a multilayered coating according to claim 14.
